(19) United States
(12) Patent Application Publication
(10) Pub. No.: US 2010/0272956 A1
(43) Pub. Date: Oct. 28, 2010

(54) RUBBER FOOT OF APPARATUS

(76) Inventor: Tatsuya Miyairi, Fussa-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/702,032

(22) Filed: Feb. 8, 2010

(30) Foreign Application Priority Data
Apr. 27, 2009 (JP) 2009-108349

(51) Int. Cl. B32B 7/02; B32B 7/04; F16M 13/00

(52) U.S. Cl. 428/139; 428/213

(57) ABSTRACT

A rubber foot attachable to an apparatus being formed with a projection on a mounting face of the apparatus in place of a conventional rubber foot, the loop-shaped projection being formed to have a first height that is lower than a height of the conventional rubber foot and to surround the circumference of the conventional rubber foot, the rubber foot including: a rubber member configured to be exposed outward; and a core portion formed by a material harder than the rubber member, wherein the rubber foot is formed to have a second height that is taller than twice the first height.

### CROSS REFERENCE TO RELATED APPLICATION(S)

The present disclosure relates to the subject matters contained in Japanese Patent Application No. 2009-108349 filed on Apr. 27, 2009, which are incorporated herein by reference in its entirety.

### FIELD

The present invention relates to a rubber foot that is made of an elastic material such as a rubber for slip prevention, the rubber foot being capable of changing its shape so as to be suitable for the height of the bottom surface a case even if the bottom surface is not altered.

### BACKGROUND

For example, electronic apparatus such as consumer electrical appliances are usually used while being placed on a flat surface such as on a shelf. In such a case, if an electronic apparatus is used in such a manner that its case made of a metal or the like is in direct contact with the shelf, various disadvantages may occur; for example, the shelf surface may be scratched or noise may be generated due to vibration. In order to eliminate these disadvantages, members made of an elastic material such as a rubber that provide a slip prevention effect and a buffering effect may be attached to the surface of a case that is to contact a shelf surface.

For example, there is proposed a rubber foot attaching structure which does not require formation of a hole or the like in an outside surface and which enables attachment and holding of a rubber foot in such a manner that no component is exposed from the outside surface. An example of such structure is disclosed in JP-A-2007-304171.

Where rubber feet are used for supporting a case in such a manner that the case surface is separated from a shelf surface, it is generally required that the rubber feet not be peeled off due to frictional resistance that is caused by their friction with the shelf surface even when the case receives horizontal force. Conventionally, the rubber feet are prevented from being peeled off easily from the attachment surface even if they receive horizontal force by disposing them inside concave portions of the case.

The structure which supports a case in such a manner that rubber feet made of an elastic material such as a rubber are disposed inside concave portions of the case of an apparatus is used widely because it is low in cost and the rubber feet are not prone to be peeled off depending of their height.

However, the depth of the concave portions needs to be adjusted according to the height of the bottom surface of a case that is supported by the rubber feet. To support a case by the rubber feet at an arbitrary height, the height of the rubber feet has a limit because the projections are formed in advance and hence their depth is predetermined. On the other hand, forming tall projections in advance may affect the thickness of a case and its internal space.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIGS. 1A and 1B show an example apparatus which is provided with rubber feet.

FIG. 2 is an enlarged view of one of the rubber feet shown in FIG. 1B.

FIGS. 3A and 3B show a rubber foot according to an embodiment.

FIGS. 4A-4C show example rubber feet which are employed for different distances between the apparatus and the placement surface.

### DETAILED DESCRIPTION OF THE EMBODIMENT(S)

An example of a rubber foot according to an embodiment of the present invention will be hereinafter described width reference to the drawings.

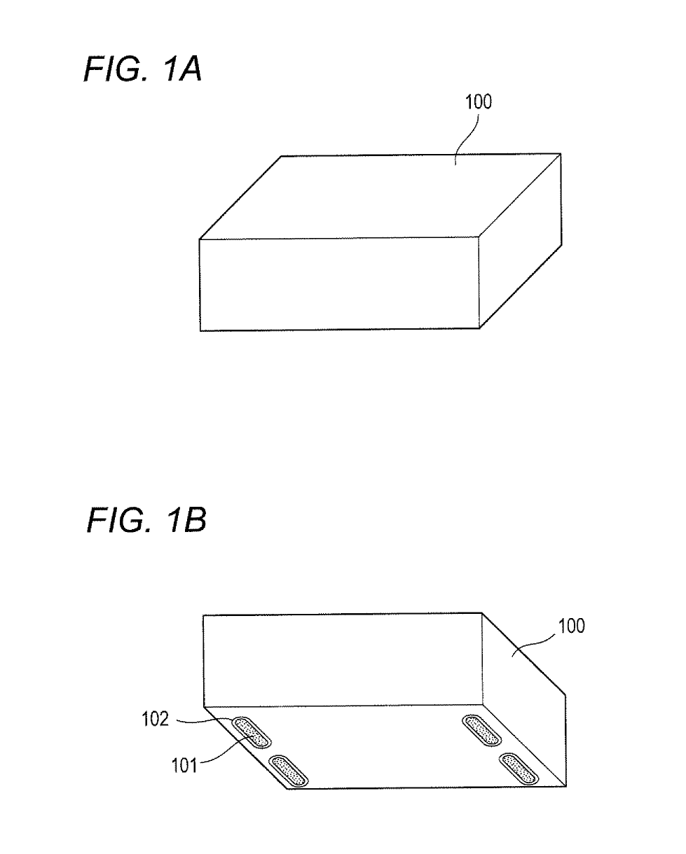

FIGS. 1A and 1B show an example apparatus which is provided with rubber feet. An apparatus 100, rubber feet 101, and loop-shaped projections 102 are shown in FIGS. 1A and 1B.

FIG. 1A is a perspective view, as viewed obliquely from above, of the apparatus 100 which is placed on a suitable place.

The apparatus 100 may be any type of apparatuses, such as a TV receiver, a refrigerator, a microwave oven, a video recorder, a PC (personal computer), and an STB (set-top box). It is assumed that the apparatus 100 has a box-shaped case and is used in a state that it is placed on a horizontal surface such as the surface of a desk or a shelf. As shown in FIG. 1B, the bottom surface of the apparatus 100 is provided with the plural rubber feet 101.

Each rubber foot 101 is a member made of an elastic material such as a rubber which provides a slip prevent effect and a buffering effect. In view of the cost, rubber feet, including the inside, are usually made of the same material. It is also assumed here that each rubber foot 101 is made of a single material. Although the apparatus 100 shown in FIGS. 1A and 1B is provided with four rubber feet 101, the invention is applicable irrespective of the number of rubber feet.

The loop-shaped projections 102, which are parts of the case 100, are formed so as to surround the respective rubber feet 101, that is, to be parallel with the peripheries of the latter. The principal function of the projections 102 is to sustain the force that is exerted on the rubber feet 101 when horizontal force acts on the apparatus 100 which is placed on a certain surface, and to thereby render the rubber feet 101 less prone to be peeled off.

The loop-shaped projections 102 may be formed to have any shape in plan view, such as an oval shape, a triangle shape, a quadrangle shape. The loop-shaped projections 102 according to the embodiment is assumed to have a closed loop shape, however, the loop-shaped projections 102 may be formed to have an opened loop shape that partially surrounds the rubber feet 101.

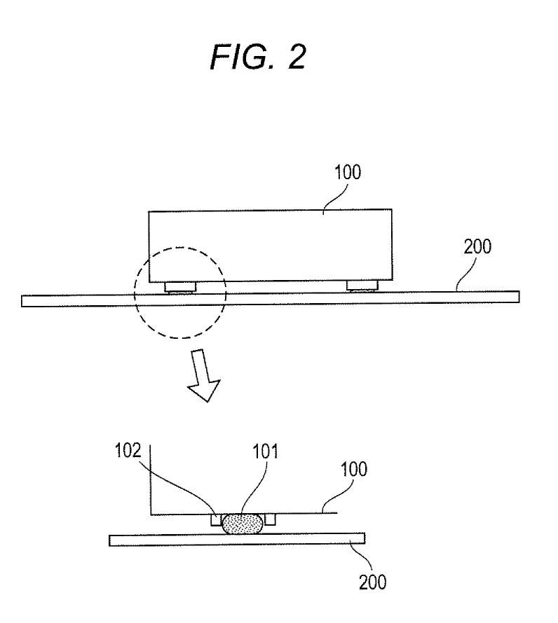

FIG. 2 is an enlarged side view of one of the rubber feet 101. The rubber feet 101 are attached to the apparatus 100 which is placed on a shelf 200.

As seen from the side view of FIG. 2, whereas the rubber feet 101, which are made of an elastic material, are in contact with the surface of the shelf 200, the projections 102 have such a height as not to be in contact with the surface of the shelf 200. That is, the projections 102 are formed to be lower in height than the rubber feet 101. Horizontal movement of the rubber feet 101 which are made of am elastic material can be suppressed effectively by giving the projections 102 a certain height. Various factors are involved in determining the height of the projections 102, and it is preferable that their height be ½ or more of the height of the rubber feet 101.

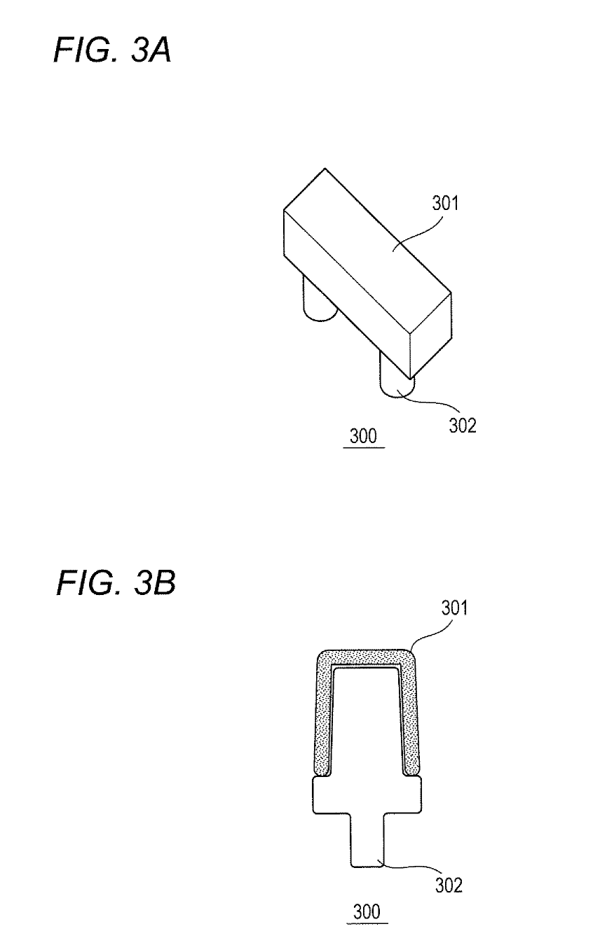

FIGS. 3A and 3B show a rubber foot 300 according to an embodiment.

The rubber feet 300 are used for supporting the apparatus 100 at a higher position than with the rubber feet 101. The rubber feet 300 are intended to provide a higher quality apparatus in which the rubber feet 300 do not come off due to insufficient strength or the like without the need for charging the shape on the side of the apparatus 100 such as the height of the projections 102 which are designed for the rubber feet 101.

FIGS. 3A and 38 area perspective view and a sectional view, respectively, of each rubber foot 300. The rubber foot 300 is composed of two members, that is, a surface foot portion 301 made of an elastic material such as a rubber and projecting portions 302.

The foot portion 301 corresponds to the above-described rubber foot 101. When the apparatus 100 is placed on the shelf 200, the foot portions 301 are brought into contact with the surface of the shelf 200 and thereby exercise a slip prevention effect and a buffering effect.

The projecting portions 302 serve to assure that the rubber feet 300 are attached to the apparatus 100 reliably rather than support, as feet, the weight of the apparatus 100. More specifically, for example, the projecting portions 302 can be used to fix the rubber feet 300 to the apparatus 100 reliably by causing the projecting portions 302 to penetrate through the wall of the case of the apparatus 100 and welding them to the case from inside in a state that the rubber feet 300 are placed inside the respective projections 102. The projecting portions 302 are made of a material such as plastics that is more robust than rubbers (elastic materials). The projecting portions 302 may be made of a metal, a hard rubber, or the like.

FIG. 3B is a sectional view of an example of the rubber feet 300. The rubber feet 300 according to the embodiment are configured by two members. The rubber feet 300 has a core portion that is formed monolithically with the projecting portion 302 and a elastic member such as rubber formed on the core portion at a part corresponding to the foot portion 301. With the above structure, the rubber feet 300 are given high strength and do not come off to secure a necessary height of the apparatus 100 even if the apparatus 100 is designed for the rubber feet 101.

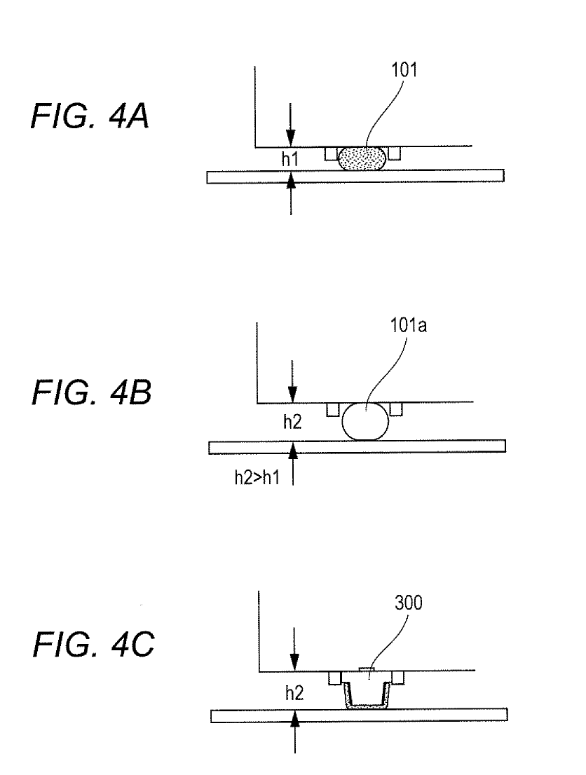

FIGS. 4A-4C show example rubber feet which are employed for different distances between the apparatus 100 and the placement surface.

FIG. 4A is a side view showing the apparatus 100 which is designed for the rubber feet 101 and one of the rubber feet 101 attached. The bottom surface of the apparatus 100 has a height h1 with respect to the surface of the shelf 200.

To obtain a height h2 which is greater than the height h1 (see FIG. 4B), rubber feet 101a are necessary that are tall enough to provide the height h2. However, if the rubber feet 101a were simply attached which are made of an elastic material such as a rubber and are tall enough to provide the height h2, the rubber feet 101a might wobble because they are made of an elastic material or come off receiving excessive horizontal force due to an insufficient height of the projections 102.

In contrast, when the height h2 is necessary, it is appropriate to use the rubber feet 300, which do not wobble (see FIG. 3C). Furthermore, the rubber feet 300 whose projecting portions 302 are welded to the case of the apparatus 100 from inside can be so strong as not to come off without requiring a design change of the apparatus 100.

As described above, this embodiment can provide a rubber foot which is configured so as not to be prone to be peeled off and to be able to support a case at a higher position even if the case is not altered, as well as an apparatus provided with such rubber feet.

Although the embodiment according to the present invention has been described above, the present invention is not limited to the above-mentioned embodiment but can be variously modified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A rubber foot attachable to an apparatus being formed with a projection on a mounting face of the apparatus in place of a conventional rubber foot, the projection being formed to have a first height that is lower than a height of the conventional rubber foot and to surround the circumference of the conventional rubber foot, the rubber foot comprising:
a rubber member configured to be exposed outward; and
a core portion formed by a material harder than the rubber member,
wherein the rubber foot is formed to have a second height that is taller than twice the first height.

2. The rubber foot of claim 1, wherein the core portion comprises a projecting portion that is configured to be inserted into a hole formed on the mounting face of the apparatus and to be welded inside the apparatus.

3. The rubber foot of claim 1, wherein the projection is formed to have a looped shape to surround the entire circumference of the conventional rubber foot.

4. An apparatus comprising:
a projection formed on a mounting face to receive a conventional rubber foot, the projection being formed to have a first height that is lower than a height of the conventional rubber foot and to surround the circumference of the conventional rubber foot; and
a rubber foot attachable to the mounting face in place of the conventional rubber foot, the rubber foot comprising:
a rubber member configured to be exposed outward; and
a core portion formed by a material harder than the rubber member,
wherein the rubber foot is formed to have a second height that is taller than twice the first height.

5. The apparatus of claim 4, wherein the core portion comprises a projecting portion that is configured to be inserted into a hole formed on the mounting face and to be welded inside the apparatus.

6. The apparatus of claim 4, wherein the projection is formed to have a looped shape to surround the entire circumference of the conventional rubber foot.
